(19) United States
(12) Patent Application Publication
(10) Pub. No.: US 2004/0038706 A1
(43) Pub. Date: Feb. 26, 2004

(54) Telephone call routing

(76) Inventor: Amos S. Wasser, Vienna (AT)

Correspondence Address: GREENBERG TRAURIG LLP, 2450 COLORADO AVENUE, SUITE 400E, SANTA MONICA, CA, 90404, US

(21) Appl. No.: 10/648,070

(22) Filed: Aug. 26, 2003

Related U.S. Application Data
(63) Continuation of application No. 09/692,764, filed on Oct. 19, 2000.

(51) Int. Cl. H04M 1/00

(52) U.S. Cl. 455/551; 455/558

(57) ABSTRACT

Provided is an apparatus for wireless communications that includes: means for wirelessly communicating with a base station in accordance with a first protocol that permits the apparatus to function as a telephone; means for permitting a user to designate a telephone number for a remote device that the user desires to contact; means for identifying an access telephone number that is different than the telephone number; means for providing the access telephone number to the base station, in accordance with the first protocol, so as to indicate that a connection is desired with a routing system corresponding to the access telephone number; and means for providing the telephone number to the routing system in accordance with a second protocol (e.g., using the telephone connection established with the routing system), so as to indicate that a connection is desired with the remote device. In addition, the invention is directed to facilitating telephone-based communications. Initially, a contact telephone number is assigned to each of a number of different subscribers. An electronic message that has been formatted in accordance with an established protocol is received from a particular subscriber from among the different subscribers, the message identifying a current telephone number for the particular subscriber. A telephone call is received on the contact telephone number for the particular subscriber, and the telephone call automatically is forwarded to the current telephone number by dialing the current telephone number.

### BACKGROUND OF THE INVENTION

1. Field of the Invention

The present invention relates to systems and techniques for improved routing of telephone calls, and is particularly applicable to wireless telephone systems, such as wireless systems operating on any of the Global System for Mobile Communications (GSM) standards. However, the invention is applicable to other telephone communications systems as well.

2. Description of the Prior Art

In wireless communications technology, user data (e.g., speech, signaling messages, alphanumeric data) modulate a radio frequency signal for transmission and reception between a base station and a mobile unit. The radio spectrum allocated by regulatory authorities for a wireless system is “trunked” to allow simultaneous use of a spectrum block by multiple units.

Various techniques exist for such trunking. For example, in frequency-division multiple access (FDMA) systems, the frequency spectrum is divided into frequency channels comprised of distinct portions of the spectrum. These frequency channels are then allocated as needed. FDMA alone is commonly used in analog cellular wireless communications systems.

Another common trunking system is the time-division multiple access (TDMA) system. TDMA is commonly used in combination with an FDMA structure. In TDMA, data to be communicated are first digitized and compressed to eliminate redundancy, thereby decreasing the average number of bits required to be transmitted and received for the same amount of information. The time line for each of the frequency channels used by the TDMA system is divided into “frames” (e.g., 4.615 ms (millisecond) time intervals) and each of the users sharing the common channel is assigned a time slot (e.g., a 577 μs (microsecond) slot) within each frame. Each user then transmits or receives a burst of data during its assigned time slot and does not transmit or receive during other times. With the exception of delays required by the bursty data transmission, which typically are small enough to be largely unnoticeable, the TDMA system will appear to the users sharing the frequency channel to have provided an entire channel to each user. The FDMA and TDMA combination technique is used by the GSM digital cellular systems.

Yet another method for sharing a common channel between multiple users is the code division multiple access (CDMA) technique, which uses direct sequence spread spectrum modulation. CDMA is relatively new to cellular technology and is one of the accepted techniques to be included into the next generation of digital cellular systems in the United States. Several different CDMA standards have evolved. As with TDMA, CDMA systems are used in transmitting digital data and are typically used in conjunction with a FDMA structure. However, unlike the TDMA systems, the CDMA systems generally do not separate the multiple users of a common frequency channel using time slices. Rather, in CDMA multiple users are separated from each other within a frequency channel by superimposing a user-specific high-speed code (e.g., 1.2288 megabits per second) on the data of each user (which may, for example, be encoded at 19.2 kilobits per second). In this example, a frequency channel 1.2288 MHz (Megahertz) wide can accommodate 64 different users. Because the applied code has the effect of spreading the bandwidth of each user's transmission, the CDMA system is often called a “spread spectrum” system. In addition, because the spreading codes are user-specific, decoding (or tuning to the appropriate subchannel) can be readily accomplished by applying the same code at the receiver.

In connection with one of the above trunking techniques, a wireless system typically also employs a cellular arrangement, in which a number of networked base station transceivers each covers a relatively small geographic area (often called a “cell”). The communications among adjacent cells are separated using one of the above trunking techniques that is appropriate to the wireless system. At the same time, non-adjacent cells typically can use the same channel (however defined), thus allowing re-use of bandwidth. As a result, such cellular arrangements can be said to utilize spatial division multiple access (SDMA) in addition to whatever type of trunking is employed.

Logging into a wireless system typically involves first acquiring the signal of, and then registering with, a base station for the desired wireless network. Most commonly, a single wireless telephone has stored within it subscriber information for a single wireless system. Such information typically includes a user identification, as well as the frequency band, spreading code, and/or other information necessary to acquire a base station in the wireless system. However, in certain wireless systems, such as GSM, a separate subscriber identity module (SIM) is utilized and stores such information. Such an arrangement allows the wireless telephones in the system to be more or less interchangeable, with all account and other personal information residing on a small, relatively inexpensive and often easily portable SIM card.

Wireless communications systems permit telephone calls to be placed and received anywhere within the region served by the wireless network. However, the present inventor has discovered certain shortcomings with conventional wireless communications systems. First, wireless systems often are geographically limited. For example, in Europe it is common for each system to cover only a single country. As a result, people who travel often are required to maintain accounts with several different wireless systems. This typically means having multiple different telephone numbers, which can make it difficult for others to reach such people. Moreover, each time a new system is desired the user typically is required to subscribe to the new system, and may have to obtain a new telephone or a new SIM card, or at least to have his existing SIM card programmed accordingly.

In addition, such wireless networks often require the subscriber to use a designated long distance carrier or limit the subscriber to one of a relatively small number of long distance carriers. Moreover, the wireless network may similarly limit the available choices of long distance plans.

### SUMMARY OF THE INVENTION

The present invention addresses these problems by providing a wireless device that, in response to an input telephone number, dials an access telephone number for a routing system and then provides the telephone number to the routing system to obtain a connection with a remote device corresponding to the telephone number.

Thus, in one aspect the invention is directed to an apparatus for wireless communications that includes: means for wirelessly communicating with a base station in accordance with a first protocol that permits the apparatus to function as a telephone; means for permitting a user to designate a telephone number for a remote device that the user desires to contact; means for identifying an access telephone number that is different than the telephone number; means for providing the access telephone number to the base station, in accordance with the first protocol, so as to indicate that a connection is desired with a routing system corresponding to the access telephone number; and means for providing the telephone number to the routing system in accordance with a second protocol (e.g., using the telephone connection established with the routing system), so as to indicate that a connection is desired with the remote device.

By establishing a telephone call using a routing system in the foregoing manner, a wireless device according to the present invention often will allow a user to more flexibly choose which telephone service provider will be used for any given telephone call. For example, if an access telephone number is used that is accessible via the wireless system at no additional charge, the user often will be able to avoid, or at least reduce, long distance charges for certain telephone calls.

In the preferred embodiment of the invention, the means for accessing and utilizing the routing system are included within a subscriber identity module (SIM) in the wireless device. As a result, it is often possible to utilize the techniques of the present invention within a conventional wireless telephone or other device by simply replacing the SIM.

In another aspect, the invention is directed to an apparatus for insertion into a wireless device, the apparatus including: means for inputting a telephone number; means for inputting an instruction to call the telephone number; means for identifying an access telephone number that is different than the telephone number; means for causing the wireless device to establish a connection to a routing system corresponding to the access telephone number; and means for causing the wireless device to transmit the telephone number to the routing system in a manner so as to indicate that a connection is desired with a remote device corresponding to the telephone number.

In a still further aspect, the invention is directed to facilitating telephone-based communications. Initially, a contact telephone number is assigned to each of a number of different subscribers. An electronic message that has been formatted in accordance with an established protocol is received from a particular subscriber from among the different subscribers, the message identifying a current telephone number for the particular subscriber. A telephone call is received on the contact telephone number for the particular subscriber, and the telephone call automatically is forwarded to the current telephone number by dialing the current telephone number.

In accordance with the foregoing technique, a user often can have the ability to give out a single telephone number. When a telephone call is subsequently received at that telephone number, the call typically can be forwarded to the telephone number that the user is currently using. Moreover, because the current telephone number is received according to an established protocol, it is often possible for a system implementing the foregoing technique to automatically update its database.

In a still further aspect, the invention is directed to an apparatus for communicating over different communications networks. The apparatus includes: means for storing login information for different telephone communications networks; means for selecting one of the different telephone communications networks; means for, automatically in response to the selection, logging into the selected telephone communications network so as to allow the apparatus to receive and initiate telephone calls; and means for, automatically in response to the selection, transmitting a message via the selected telephone communications network to an entity that is not a part of the selected telephone communications network. According to this aspect of the invention, the message that is sent identifies a telephone number at which the apparatus is reachable while logged into the selected telephone communications network, and the message is sent according to a pre-established protocol.

By automatically sending a message that identifies a user's current telephone number in the foregoing manner, the present invention often can facilitate automatic telephone call routing by a routing system.

The foregoing summary is intended merely to provide a brief description of the general nature of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 is a simplified block diagram illustrating an overall system configuration according a representative embodiment of the present invention.

FIG. 2 is a flow diagram illustrating initial processing by a mobile wireless device according to a representative embodiment of the invention.

FIG. 3 is a flow diagram illustrating a method for placing a telephone call according to a representative embodiment of the invention.

FIG. 4 is a flow diagram illustrating a method for routing telephone calls according to a representative embodiment of the invention.

### DESCRIPTION OF THE PREFERRED EMBODIMENT(S)

The present invention concerns improved systems and methods for telephone call routing. In the preferred embodiment of the invention, the techniques described below are implemented in connection with a GSM wireless communications system. Accordingly, much of the description below will assume such an environment. However, it should be understood that the invention is applicable to other wireless and hardwired communications systems as well.

System Description.

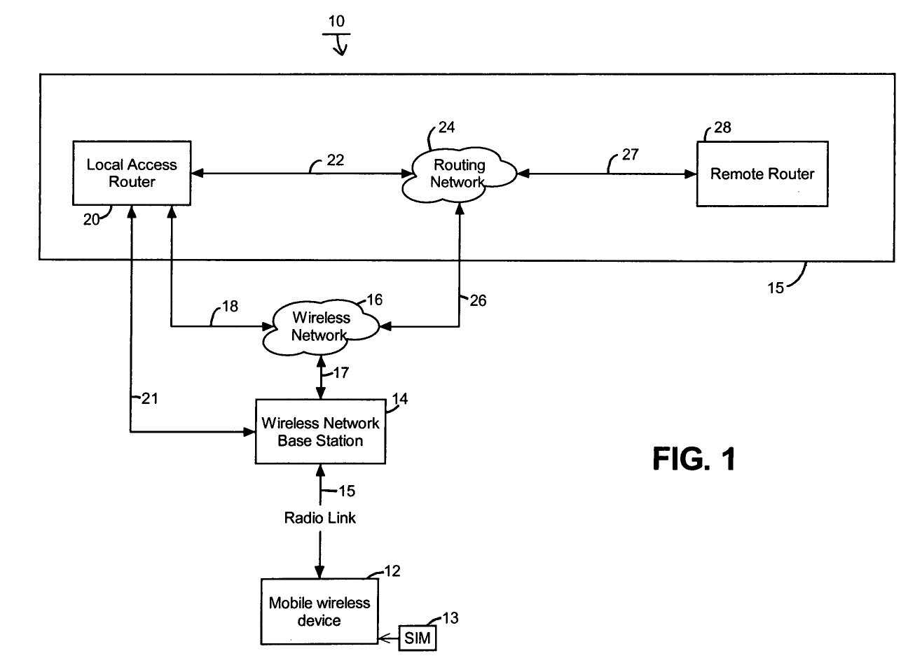

FIG. 1 illustrates the configuration of an overall system 10 according to a representative embodiment of the present invention. Included in system 10 is a mobile wireless device 12, into which preferably is inserted a subscriber identity module (SIM) 13. Wireless device 12 may be a wireless telephone, a wireless-enabled personal digital assistant (PDA), or any other device for communicating with a wireless network. Preferably, device 12 includes a keypad for entering information, a microphone or similar device for converting audio to an electrical signal, a speaker or similar device for converting electrical signals to audio, and a display monitor (e.g., a liquid crystal display) for outputting text-based messages and graphics. More preferably, wireless device 12 also is provided with the appropriate software protocols, signal processing hardware, and other functionality so as to make it capable of functioning as a wireless telephone.

In the preferred embodiment of the invention, most of the unique functionality performed by wireless device 12 is encoded on SIM 13. However, it is also possible to embed most or all of such functionality in wireless device 12. The actual allocation of functionality preferably will be governed by the expected needs of the user, engineering tradeoffs and existing protocols.

SIM 13 preferably is a “smart card” that includes a microprocessor and random access memory (RAM) for storing data and computer-executable process steps. Preferably, SIM 13 includes the same interfaces that are present in conventional SIM cards, and is otherwise sized and shaped similarly to conventional SIM cards, so as to be capable of being interchangeably inserted into conventional wireless telephones and other devices. More preferably, SIM 13 can be easily inserted into and removed from wireless device 12.

In the preferred embodiment of the invention, SIM 13 stores subscriber information for plural different wireless networks, thereby allowing wireless device 12 to log into each such different wireless network as a subscriber, rather than having only a single wireless network account and logging into others only on a roaming basis. In addition, SIM 13 preferably also stores a table of local access telephone numbers for calling various local access routers, rate information, network accessing and messaging information, and location information, all as described in more detail below.

Wireless device 12 is capable of communicating with a wireless network base station 14 via a wireless connection 15 (typically a radio link). Base station 14, in turn, connects to and is a part of wireless network 16. Typically, most of the interconnections within wireless network 16, including the connection to base station 14, are made via hardwired cables (e.g., copper and/or fiber optic). Although not specifically shown in FIG. 1 for simplicity of illustration, wireless network 16 typically will include: other similar base stations, at least one switching center, and various other control centers. Such components of a wireless network are well known in the art, and therefore are not discussed in detail here.

Wireless network 16 also connects to one or more different points within routing system 15. In this regard, routing system 15 preferably includes a routing network 24 that interconnects various local access routers and other routers, such as routers 20 and 28, using hardwired interconnections. Each such router preferably is configured as a switching center for routing telephone calls, as described in more detail below, and functions as a single node on routing network 24. In addition, routing center 15 may include one or more control centers. In this regard, although routing system 15 generally will include many different nodes, such nodes preferably will function collectively. The routing system 15 therefore may be centrally controlled or the control of routing system 15 may be distributed among the various nodes of network 24, using processing techniques that are well-known in the art.

Base station 14 connects to local access router 20 via link 21. Preferably, router 20 is geographically close to base station 14, or at least within the same local call area of wireless network 16 as base station 14. Generally, base station 14 and/or the rest of wireless network 16 generally will include various other links, such as links 18 and 26, to various nodes on routing network 24. Any of such links may be a permanent connection and/or a part of wireless network 16 or routing network 24 (e.g., in the event that there is an affiliate relationship between the operator of wireless network 16 and the operator of routing system 15), or else may be a periodically created temporary connection via one or more public networks, such as a public telephone network or the Internet (e.g., in the event that no such affiliate relationship exists).

In the preferred embodiment of the invention, routing network 24 preferably is implemented as an asynchronous transfer mode (ATM) network. However, any other technology may instead be used. The functionality of routing system 15 will become apparent below in connection with the discussions of the methods of the present invention.

Initialization Process.

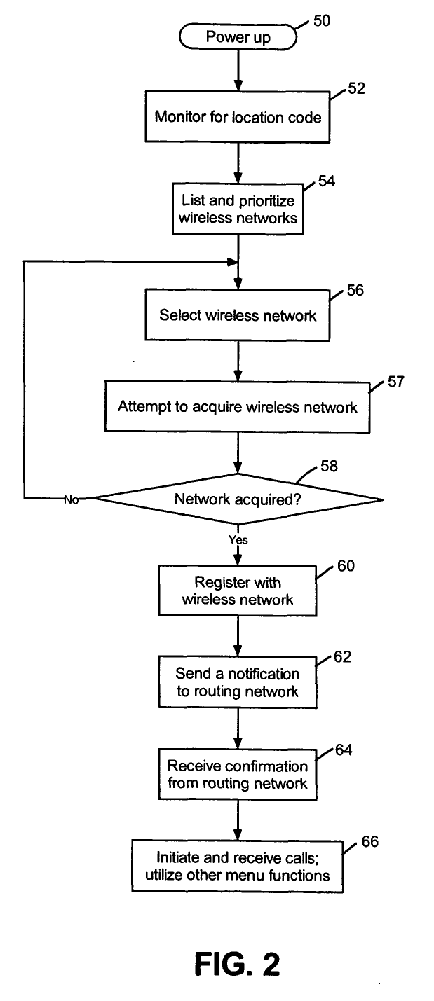

FIG. 2 is a flow diagram illustrating initial processing performed by wireless device 12 according to a representative embodiment of the invention. Briefly, according to FIG. 2, device 12 is powered up; monitors for a location code; generates a list of wireless networks based on the obtained location code; selects, acquires and registers with a wireless network; notifies a routing network; receives confirmation from the routing network; and then begins sending and receiving calls, as well as performing other functions.

In more detail, immediately after power-up 50 of the wireless device 12, in step 52 device 12 begins monitoring for a location code. More preferably, SIM 13 causes device 12 to perform such monitoring. In this regard, the base stations in a wireless network frequently broadcast certain information on a broadcast channel. Included in this information frequently is a location code and, very frequently, a country code. Thus, in the GSM standard, a location area identification (LAI) periodically is broadcast on the broadcast control channel (BCCH). The LAI includes a country code, a mobile network code and a location area code.

As noted above, SIM 13 preferably stores information for plural different wireless networks. In the event that such different networks use different sub-channels (e.g., in the frequency domain and/or using different spreading codes) for their BCCHs, then SIM 13 preferably stores such information and causes device 12 to scan each such BCCH until a signal is received and the location code (e.g., the LAI) is detected.

In step 54, wireless device 12 creates and prioritizes a list of wireless networks based on the location code obtained in step 54. Preferably, such processing is performed by SIM 13 within device 12. Typically, SIM 13 will only store a single entry for each country. Therefore, the list will include only one entry, in accordance with the identified country code, and no prioritization is required. However, if more than one wireless network is stored for the identified location code, then SIM 13 may prioritize such networks, such as based on stored information regarding pricing plans for the various wireless networks in conjunction with clocking information indicating day of the week and time of day, based on any other information stored in or available to SIM 13, based on login history (e.g., with networks that have been logged into most recently and/or given higher priority), or even arbitrarily or based on non-material considerations (e.g., by prioritizing alphabetically).

It is noted that it also possible to have omitted step 52. Similarly, it is possible that no location code was identified in step 52. In either of these events, SIM 13 may prioritize its stored entries for the different wireless networks based on other criteria, such as geographic proximity to the last wireless network acquired, based on frequency with which the user has used the wireless device 12 (or the SIM 13) in a geographic region, and/or based on stored pricing information. In addition, such prioritization may occur at multiple levels. For example, if wireless device 12 (or the SIM 13) last acquired a wireless network in Italy, then SIM 13 may prioritize all wireless networks covering Italy highest and, if more than one, prioritize at the next level based on stored pricing information; then, returning to the higher level of prioritization, wireless networks covering all countries adjacent to Italy may be prioritized next highest, again with intra-group prioritization based on stored pricing information. In addition to (or instead of) prioritization based on geographic proximity, in the preceding example SIM 13 may determine that the user most frequently logs onto systems in Belgium and therefore prioritize wireless networks covering Belgium after those covering Italy. Still further, it is possible to allow the user to manually designate the priorities and/or the country or other location code, or to use any combination of manual and automatic prioritization.

Thus, generally speaking, in the preferred embodiment of the invention step 54 includes the substeps of narrowing the list of potential wireless systems (e.g., based on an obtained location code) and then prioritizing the remaining list. However, in alternative embodiments of the invention either or both of these substeps may be omitted.

In step 56, a wireless network is selected. If control has just passed from step 54, this ordinarily will be the network with the highest priority. If control has passed from step 58 (described below), preferably this will be the next network on the prioritized list or, if the previous network was the last on the list, it will be the first on the list.

In step 57, wireless device 12 attempts to acquire a base station for the selected wireless network. This acquisition process is well-known in the art and is not discussed in detail here. Any information required for such acquisition, such as the required network-specific frequency channel or other network-specific information preferably is stored in SIM 13 and provided to device 12 for use in the acquisition process. Otherwise, the acquisition preferably is performed primarily by hardware and software within device 12 that is largely independent of SIM 13.

In step 58, a determination is made as to whether the wireless network has been acquired. If so, processing proceeds to step 60. If not, processing returns to step 56 to attempt to acquire the next network on the ordered list created in step 54.

In step 60, device 12 registers with the acquired wireless network 16. The registration process is well-known in the art and therefore is not discussed in detail here. In the GSM standard, registration typically includes a subscriber authentication process in which device 12 receives from base station 14 a random number, processes the random number using the subscriber's authentication Ki to obtain a signature response, and then transmits the signature response back to base station 14. Once registered, wireless device 12 is able to initiate and receive telephone calls via wireless network 16.

In step 62, device 12 sends to routing system 15 a notification that it has registered with wireless network 16. Such notification may occur in any of a number of different ways. For example, it is possible for device 12 to initiate a telephone call to routing system 15 and then transmit the information over the telephone link, either in digital or analog format. In this case, routing system 15 preferably is accessible by dialing a local telephone number, e.g., corresponding to local access router 20, thereby avoiding the necessity of incurring long distance charges. Thus, in the preferred embodiment of the invention, a sufficient number of local access routers are provided to obtain wide local access coverage.

Alternatively, the notification may be sent in this step 62 as a discrete one-way digital message from wireless device 12 to base station 14. Thereafter, base station 14 may forward such a message to routing system 15. With regard to the first leg of this messaging, for example, the GSM protocol allows transmission of short messages between the base station and the mobile station using the Short Message Service (SMS). Accordingly, the notification can be sent to base station 14. Then, provided that an appropriate affiliate relationship has been established between the operator of wireless network 16 and the operator of routing system 15, base station 14 (or another node on wireless network 16) can transmit the message on to routing system 15 via an established protocol. In a related variation, the operator of wireless network 16 may permit its subscribers to use SMS to send short e-mail messages or similar types of messages. In this case, no affiliate relationship is necessary between the operators of the two networks, and device 12 can simply send the message addressed to routing system 15.

It is noted that wireless networks in general, and GSM in particular, are typically designed so as to allow the wireless network operator significant flexibility in providing services to their subscribers. Accordingly, there may be a variety of options for transmitting the notification in this step 62. Preferably, one or more of such options is stored on the SIM for each supported wireless network. More preferably, the option actually used is selected to minimize the cost to the user of sending the notification and/or to attempt to insure that the notification reaches system 15 within a specified period of time.

In any event, such notification preferably is in accordance with an established protocol that permits routing system 15 to automatically update its database. It is noted that similar notifications may be provided in the event that: wireless device 12 switches to using a different wireless system, wireless device 12 begins using a different telephone number on the current wireless system, or any other change in status occurs. In addition, a notification may be periodically sent to routing system 15 irrespective of any change in status, in order to let routing system 15 know that device 12 is still registered with the same wireless system (e.g., device 12 has not moved into an area that is not covered by wireless network 16 or otherwise been dropped from wireless network 16).

In step 64, a confirmation is received by wireless device 12 from routing system 15 indicating that routing network 15 has received the notification. Such confirmation may be provided in any manner described above for providing the notification in step 62 (e.g., over an established telephone call or, if available, by e-mail using SMS). Upon receipt of such confirmation, SIM 13 preferably causes wireless device 12 to display a message on the output display of wireless device 12 indicating that the forwarding service is now available. On the other hand, if no confirmation notice is received (e.g., within a predetermined amount of time), SIM 13 preferably causes wireless device 12 to display a message on the output display of wireless device 12 indicating that the call forwarding service is not available. In the remainder of the discussion, unless specifically noted otherwise, it is assumed that the call forwarding service provided by routing system 15 is available.

In step 66, wireless device 12 is capable of receiving telephone calls, initiating telephone calls, and performing all other functionality of a device registered with wireless network 16. Initially, wireless device 12 typically will be in a standby mode, monitoring a paging channel for incoming telephone calls and awaiting instructions from the user via the user interface of wireless device 12. Some of this various functionality is described in more detail below.

Telephone Call Initiation.

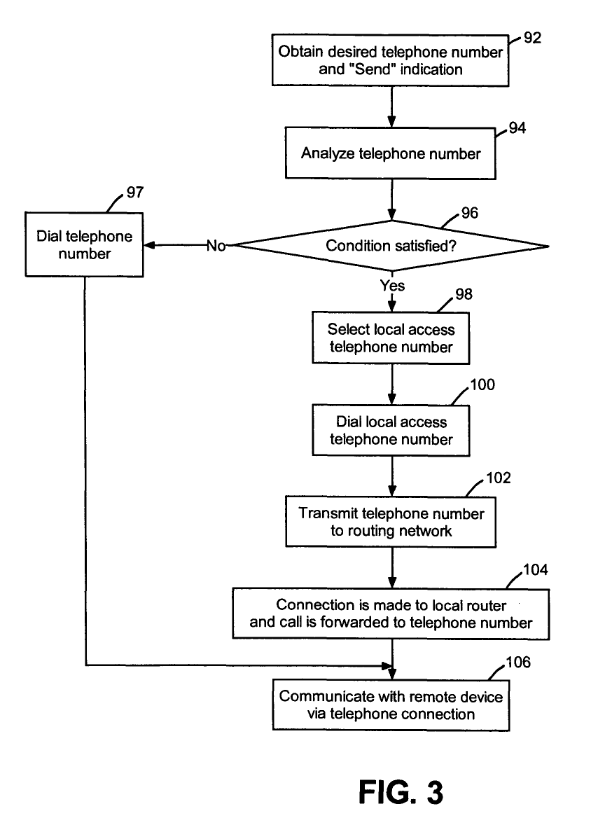

FIG. 3 is a flow diagram illustrating a method for initiating a telephone call according to a representative embodiment of the invention. Briefly, according to FIG. 3, a desired telephone number and a “Send” indication are obtained; the telephone number is analyzed; if a specified condition is not satisfied, the telephone number is dialed and communications proceed normally; on the other hand, if the condition is satisfied, a local access telephone number is selected and dialed, the telephone number is transmitted to a routing network, a connection is made to the local router, the call is forwarded to the telephone number, and then communications proceed normally.

In more detail, in step 92 a desired telephone number and a “Send” indication are obtained. Ordinarily such information will be input into device 12 via its keypad by a user. However, such information can instead be obtained in any other manner, such as via a wireless connection or from internal memory according to a pre-programmed “call” instruction. As with many conventional wireless telephones, wireless device 12 immediately provides such information to the SIM, in this case SIM 13.

In step 94, SIM 13 analyzes the telephone number obtained in step 92. Preferably, this will include identifying a geographic region to which the telephone number pertains. Such analysis may involve extracting the country code, the area code or other significant digits of the telephone number and, possibly, comparing such information to information pertaining to the location of, or local calling area for, wireless device 12 (e.g., information derived from the location code obtained in step 52) or to information pertaining to the specific wireless network 16 with which wireless device 12 is currently registered. Preferably, the purpose of the analysis is to pre-process the telephone number to assist in making the determination in step 96. Accordingly, considerations pertaining to such analysis are described below in connection with the discussion of step 96.

In step 96, SIM 13 makes a determination as to whether the telephone number satisfies a specified condition. Preferably, the condition will be that it is less expensive to route the telephone call using routing system 15 than to place the call directly. In connection with such a determination, SIM 13 preferably stores a list of local access numbers, as well as information pertaining to the charges imposed by wireless network 16 for different telephone calls. Thus, in this case, SIM 13 can make the determination by directly comparing the cost of the telephone call if placed directly to the cost of the telephone call if placed through the nearest local access router(s). A preliminary step of narrowing down the list of potential local access routers that could be used to route the call may be performed by eliminating those that are outside the country, region or area served by the current wireless network 16 (or which would require additional charges to reach via wireless network 16).

Alternatively, the condition tested in step 96 may involve a simpler test, such as whether the telephone number corresponds to a location in the local calling area for device 12 or in the same country or other region in which device 12 presently is located. As noted above, preferably the ideal goal is to determine whether it is less expensive to route the telephone call using routing system 15 than to place the call directly. However, such a simpler test often may serve as a rough proxy for making such a determination.

It is also noted that price alone is not necessarily the only consideration. Instead, SIM 13 may factor into the condition in this step any degradation in connection quality resulting from using routing network 24, the purpose of the desired telephone connection, and/or any delays resulting from using routing network 24. Also, to the extent that price is considered, SIM 13 preferably factors into the condition any telephone call charges imposed by the operator of routing system 15, on either or both of the user of routing system 15 or the recipient of the telephone call.

In the event that the condition is satisfied, processing proceeds to step 98. If the condition is not satisfied, then processing proceeds to step 97, in which SIM 13 causes device 12 to dial the telephone number in a conventional manner, in order to establish the desired connection. As used herein, the step of dialing a telephone number is intended to include any applicable technique by which a telephone or other device transmits a request for a telephone connection with a device corresponding to the dialed telephone number.

In step 98, SIM 13 selects a local access telephone number. Generally, the local access telephone number already will have been identified in steps 94 and/or 96 in connection with the determination as to whether to use the routing system 15 at all. However, in the case that multiple telephone numbers have been identified in such steps, then one can be selected based on expected pricing considerations for the telephone call or, for example, if all are expected to be priced approximately equally, selected randomly.

In step 100, SIM 13 causes wireless device 12 to transmit to base station 14 a request for a telephone connection to local access router 20, which corresponds to the local access telephone number identified in step 98. This step may be identical to conventional techniques for establishing a telephone connection using a wireless telephone, except that the local access telephone number, rather than the input telephone number, is dialed.

In step 102, SIM 13 causes wireless device 12 to transmit the telephone number obtained in step 92 to routing system 15. This step may be performed in a number of different ways. The following lists some examples. First, SIM 13 may simply wait for the telephone connection to local access router 20 to be established and then transmit the telephone number to local access router 20 in an analog or digital format. Second, SIM 13 may send the message to routing system 15 using SMS, as described above. Alternatively, any other applicable communications services provided by wireless network 16, including any of those described above, may be utilized.

It is noted that in certain cases, such as the second case described above, SIM 13 need not wait for the telephone connection to be completed before transmitting the telephone number. In fact, in such cases, it is often not even necessary to wait until the process for establishing such a connection has begun. Accordingly, it often will be possible to perform step 102 concurrently with or even prior to step 100.

In step 104, the connection is made to local access router 20 and router 20 forwards the call to the telephone number received in step 102. This step is described in more detail below.

In step 106, the desired telephone connection has been established, and the user can communicate normally with the remote device corresponding to the telephone number obtained in step 92. Ordinarily, the user of device 12 will be unaware of whether the telephone call has been placed directly or via routing system 15.

Routing System Processing.

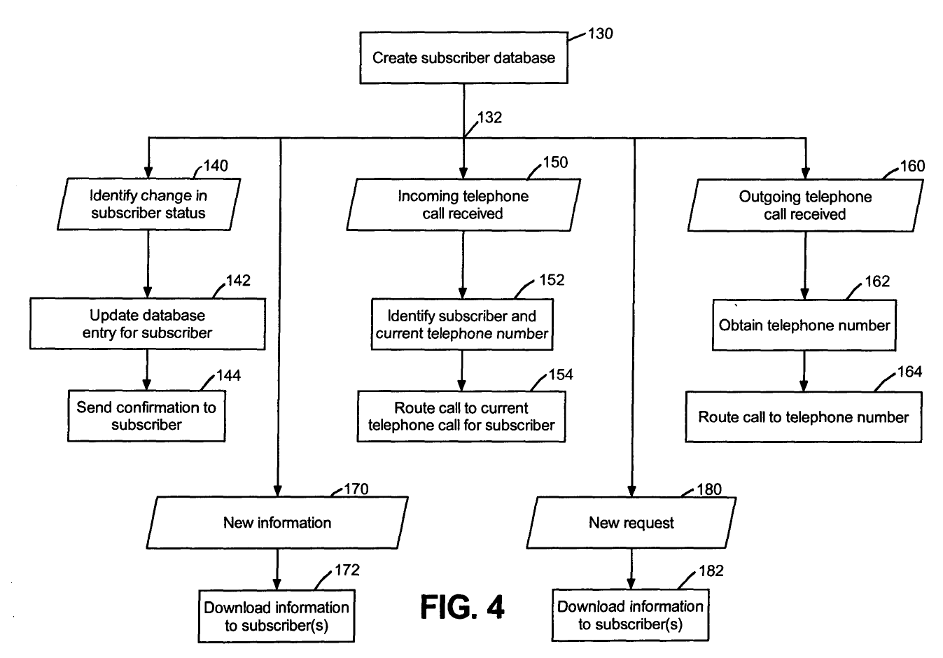

As noted above, the routing system according to the preferred embodiment of the invention includes various routers and may include other networked nodes. FIG. 4 illustrates a method for implementation by the routing system 15. The specific functionality described below in connection with FIG. 4 may be performed by any of such nodes, with the particular allocation being determined in accordance with ordinary engineering tradeoffs and cost considerations.

In step 130, the routing system 15 creates a subscriber database. Preferably, this database includes for each subscriber of routing system 15: a contact telephone number assigned by the routing system, a subscriber identification code, the wireless networks for which the subscriber has an account, a status indicator for the subscriber indicating whether the subscriber currently is using the routing system, various telephone numbers for the subscriber, hardware and/or software configuration information pertaining to the wireless device(s) and/or SIM cards used by the subscriber, and various personal information about the subscriber. Certain of such information is described in more detail below.

Once such a database has been initially established, processing may proceed along any of the indicated paths, in response to any of the triggering conditions 140, 150, 160, 170 or 180. Specifically, upon such a triggering event the processing in the corresponding path is performed until the last step has been performed; thereafter, processing returns to point 132 to await the next triggering event. In fact, because multiple nodes are used in the routing system 15, each potentially having multiple processors, multiple different paths and/or multiple different instances of a single path may be processed simultaneously by the routing system 15 of the present invention.

In step 140, routing system 15 determines that a change in status has occurred for one of the subscribers of system 15. Typically, such a determination will be made in response to a notification received by system 15 from the subscriber. Changes in status identified as a result of any such notification may include, for example: that the subscriber has just registered with a wireless network 16, that the subscriber has just switched from using wireless network 16 to using a different wireless network (not shown in the figures), or that the subscriber has disconnected from wireless network 16. Each such notification preferably identifies the subscriber and the status change information for the subscriber.

Alternatively, in step 140 system 15 may determine that a change in status has occurred based on a failure to receive a notification. For instance, in a preferred embodiment of the invention, each subscriber periodically transmits a notification indicating that it is still connected to the wireless network. Failure to receive such a notification within the specified period of time will indicate to system 15 that the subscriber was disconnected from the wireless system 16 without having had a chance to transmit to routing system 15 a notification to that effect.

Upon identifying any such change in status, processing proceeds to step 142. On the other hand, if a notification merely confirms the continued existence of the same status for a subscriber, routing system 15 preferably resets the time period in which it will expect to receive the next such notification.

In step 142, routing system 15 updates its database with the new status information included in the notification received in step 140. Such information may identify the now-current: wireless network to which the subscriber is connected, telephone number for the subscriber, or location of the subscriber.

In step 144, a confirmation is sent from routing system 15 to the subscriber (e.g., to wireless device 12) acknowledging that the update information has been received.

In step 150, an incoming telephone call is received for a subscriber on one of the assigned contact telephone numbers. As indicated above, in the preferred embodiment of the invention, each subscriber is assigned a contact telephone number by routing system 15. This single contact telephone number can be given out by the subscriber so that others can reach him, regardless of which wireless or other telephone network the subscriber is using at any particular time.

Thus, when a telephone call comes in on a particular contact telephone number in step 150, in step 152 routing system 15 preferably automatically consults its database to identify the corresponding subscriber and the current telephone number being used by the subscriber. In addition, other information may be retrieved from the database; for example, the geographic location of the subscriber may have been included in one of the notifications received in step 140 (which in turn may have been obtained as a location code by the corresponding wireless device 12 from base station 14) and stored in the database of routing system 15.

In step 154, the incoming telephone call received in step 150 is routed to the telephone number identified in step 152. This step may be performed by simply switching the call onto a public telephone network using the identified telephone number. Alternatively, using geographic location information obtained in step 152, routing system 15 may instead first route the call over its own network to a node on routing network 24 that is geographically closer to the location of the subscriber. This local router may then place the call on the public telephone network. Still further, if an appropriate affiliate relationship and corresponding network interconnections have been established, routing system 15 may directly transmit the call to wireless network 16. The precise routing technique used preferably is selected to minimize the costs associated with routing the telephone call.

In step 160, a telephone call is received by routing system 15 that is an outgoing call from one of the subscribers of system 15. In this regard, system 15 preferably has plural different local access telephone numbers for its subscribers to use, so that at least a significant number of the subscribers can contact system 15 without incurring long distance toll charges. These local access telephone numbers preferably are different than the personal contact numbers assigned to the subscribers. Thus, when a call is received on one of the local access telephone numbers, it is known to be an outgoing call placed by a subscriber.

In step 162, the telephone number to which the outgoing call is to be routed is obtained by routing system 15. As noted above in connection with step 102, wireless device 12 can transmit this telephone number to routing system 15 in a number of different ways. Preferably, system 15 has coordinated (or coordinates on-the-fly) with the wireless device 12 as to the precise technique to be used and receives the telephone number in the agreed-upon manner. One way to coordinate such transmissions and receptions is discussed below in connection with steps 170 and 172.

In step 164, the telephone call received in step 160 is forwarded to the telephone number received in step 162. Once again, the telephone call may be routed directly onto the public telephone network, first routed to a local routing node on system 15, and/or directly routed to an affiliated wireless network.

In step 170, new information is received by routing system 15. Such new information may include, for example, information pertaining to: new services available on a particular wireless network, new or modified protocols (e.g., in use by wireless network 16 or routing system 15), new or changed telephone call pricing in effect for any telephone service provider (whether currently used by routing system 15 or any of its subscribers, or potentially useful to either), a new subscription to a wireless network by one of the subscribers of routing system 15 or a change in the service plan for the subscriber, or a new or modified network configuration for routing system 15 or any other telephone service provider. As should be apparent, any or all of such new information may be subscriber-specific, wireless-network-specific or generally applicable. Unlike the information in step 140, which preferably is received according to established protocols and processed automatically, the new information in this step generally will be obtained under less well-defined circumstances and therefore may require more human operator participation to evaluate, input and/or process.

In step 172 information is downloaded to one or more subscribers in response to the new information obtained in step 170. The downloaded information may update a database in SIM 13 that stores information relating to the subscriber or the various wireless networks to which he has access and/or may update any of the programs utilized by SIM 13. For example, if routing system 15 has learned in step 170 that a new communication service is available on a particular wireless network, then routing system 15 may download an update to the SIM software for all users of that wireless network, with the update causing the SIM to utilize the new communication service for some or all of the notifications it provides to routing system 15. If routing system 15 has learned in step 170 of new telephone call pricing information or different coverage areas for a particular wireless network, then routing system 15 may download such information as an update to the SIM database for all users of that wireless network, so that the SIMs for such users can use such new information, e.g., in making the determination in step 96. On this other hand, in this latter case routing system 15 may instead (or in addition) update the actual decision-making software used by SIM 13. The determination as to how best to respond to the new information obtained in step 170, such as whether to update data or software, preferably is made according to well-known engineering tradeoffs and cost considerations.

In step 180, routing system 15 receives a request from one of its subscribers. Ordinarily, such a request will be made using the subscriber's wireless device 12. More preferably, SIM 13 is programmed to provide the user with a certain number of pre-defined request options, e.g., via a hierarchical menu structure. Accordingly, the request may be entered manually into wireless device 12, such as by pressing keys on the keypad of wireless device 12. Alternatively, the request may be generated automatically by SIM 13 (e.g., in response to some other input from the subscriber). The request may include, for example: a request for a new account with a user-designated wireless network, a request for a new account with a wireless network that covers a user-designated geographic region (e.g., a specified country), a request to download electronic cash, or a request to download a selected file (e.g., a music or other audio file).

The request may be transmitted and received via any of the techniques described above for transmitting notifications from wireless device 12 to routing system 15, or in any other manner. However, in the preferred embodiment of the invention, the request is made by wireless device 12 under the control of SIM 13 and according to an established protocol. The use of an established protocol generally will mean that the request will be in a pre-defined format, allowing routing system 15 to automatically process the request.

In step 182, the requested information is downloaded (preferably, automatically and according to an established protocol) to wireless device 12, which in turn provides such information to SIM 13. Thus, for example, in accordance with steps 180 and 182, a user of wireless device 12 may perform any of the following activities.

In the event that the user is using a wireless system in a first country and has plans to go to a second country that is not covered by that wireless system, the user may request wireless service for the second country using his wireless telephone. Preferably, such a request would be made using the keypad of the wireless telephone to select the desired country and to enter the request from a menu displayed by the wireless telephone. The list of available countries may be pre-stored on the SIM card in the users wireless telephone (possibly subject to periodic updates in accordance with steps 170 and 172, discussed above) or may be downloaded on-the-fly from routing system 15. In this regard, routing system 15 preferably has agreements in place with a number of wireless systems so that routing system 15 can assign accounts on-the-fly. The communication of the request, as well as any ancillary communications (e.g., downloading of the list of available counties) may be made using any of the techniques described herein. Upon receipt of the request, routing system 15 assigns the requested account to the user, updates its database accordingly, and then transmits to the user's wireless device the account information (e.g., Ki, IMSI, telephone number, etc.) for updating of the SIM's database. Wireless device 12 then preferably displays a message confirming that the new wireless service is now available.

In the event that the user has submitted a request to download electronic cash, routing system 15 automatically downloads such electronic cash to wireless device 12, using encryption and/or other security mechanisms. Upon receipt by wireless device 12, the information pertaining to such electronic cash is provided to SIM 13. In the event that SIM 13 is of the credit-card-sized type, SIM 13 preferably can then simply be removed and used in transactions where electronic cash is accepted. Wireless device 12 also (or instead) may be provided with an interface for transferring the electronic cash to a different card. Still further, the electronic cash downloaded in this manner may be used to make purchases directly from wireless device 12 (e.g., over the Internet if wireless device 12 is Web-enabled).

System Environment.

As indicated above, many of the methods and techniques described herein (e.g., those described above in connection with routing system 15, base station 14 or any other node on wireless network 16) can be practiced with a general-purpose computer system. Such a computer system typically will include, for example, at least some of the following components: one or more central processing units (CPUs), read-only memory (ROM), random access memory (RAM), input/output circuitry for interfacing with other devices and for connecting to one or more networks, a display (such as a cathode ray tube or liquid crystal display), other output devices (such as a speaker or printer), one or more input devices (such as a mouse or other pointing device, keyboard, microphone or scanner), a mass storage unit (such as a hard disk drive), a real-time clock, a removable storage read/write device (such as for reading from and/or writing to a magnetic disk, a magnetic tape, an opto-magnetic disk, an optical disk, or the like), and a modem. In operation, the process steps to implement the above-described methods typically are initially stored in mass storage (e.g., the hard disk), downloaded into RAM, and then executed by the CPU out of RAM.

Suitable computers and devices for use in implementing the present invention may be obtained from various vendors. Various types of computers may be used, depending upon the size and complexity of the tasks. Suitable computers include mainframe computers, multiprocessor computers, workstations, or personal computers. In addition, although a general-purpose computer system has been described above, a special-purpose computer may also (or instead) be used.

The wireless devices described above may include laptop or other portable computers, personal digital assistants (PDAs), wireless telephones or any other mobile appliance or device. Such devices typically will include special-purpose signal processing hardware in addition to general-purpose processors and other hardware. Preferably, however, such devices are small enough to be held comfortably in a single hand.

Any of the functionality described above can be implemented in software, hardware, firmware or any combination of these, with the particular implementation being selected based on known engineering tradeoffs.

It should be understood that the present invention also relates to machine-readable media on which are stored program instructions for performing the methods of this invention. Such media include, by way of example, magnetic disks, magnetic tape, optically readable media such as CD ROMs and DVD ROMs, semiconductor memory such as PCMCIA cards, etc. In each case, the medium may take the form of a portable item such as a small disk, diskette, cassette, etc., or it may take the form of a relatively larger or immobile item such as a hard disk drive, ROM or RAM provided in a computer.

Additional Considerations.

The preferred embodiment of the present invention thus concerns systems and techniques in which a mobile wireless device includes functionality to (at least in certain circumstances) route a desired telephone call through a routing system, rather than simply placing the call directly. Also provided is functionality for notifying the routing system of the current telephone number at which the mobile wireless device is reachable. As a result of this feature of the invention, the routing system can automatically route telephone calls to the mobile wireless device, regardless of the wireless system to which it is currently logged in and regardless of the current telephone number of the mobile wireless device.

It should be understood, however, that the foregoing merely discusses the preferred embodiment of the invention. Other variations are also possible. For instance, the teachings of the present invention can be extended to use of a mobile device that is capable of logging into different hardwired telephone communications systems instead of, or in addition to, wireless systems.

In addition, as discussed above, in the preferred embodiment of the invention, the routing system establishes a telephone connection to the identical telephone number submitted by the wireless device. However, in an alternative embodiment, the routing system may process the provided telephone number to find an alternate telephone number and then establish a connection between the wireless device and this alternate telephone number. This may be desirable in a number of contexts. For example, if the provided telephone number would require a long-distance toll charge call, the routing system may consult a database to find a (preferably equivalent) alternate local or toll-free (e.g., 800-) telephone number, and then dial that alternate number, thereby reducing the subscriber's long-distance charges. In another example, if the routing system determines that the line for the provided telephone number is busy or otherwise unavailable, the routing system may then search for, obtain and dial an alternate (preferably equivalent) telephone number.

As discussed above, one benefit of the present invention is that in certain embodiments a user can give out a single telephone number and have telephone calls that are made to that contact number forwarded to him, wherever he is. In the embodiment described above, all such telephone calls are automatically forwarded by the routing system. However, in alternative embodiments only certain of such telephone calls (such as those satisfying specified, e.g., predetermined, criteria) are forwarded to his current telephone number, and all other telephone calls received on the contact telephone number are either forwarded to a different (e.g., the subscriber's office) telephone number or are placed into voicemail by the routing system. Such criteria may include, for example: only those telephone calls from telephone numbers on a specified list (e.g., determined using a Caller ID function), or only those callers who enter an appropriate code after the telephone call has been answered by the routing system.

Also, in the above discussion certain functionality is attributed to the SIM in the wireless device. However, any or all of such functionality may instead be provided by other portions of the wireless device. Accordingly, references above to the SIM are intended to refer only to the preferred embodiment.

In the above discussion, it is noted that certain established protocols are utilized for transmitting messages. In the preferred embodiment, such protocols require that the subject message be in a pre-defined format, allowing the recipient to process the message using automated processing. Moreover, although the different messages generally will be transmitted using different protocols, it is also possible for such protocols to be very similar or even identical.

Lastly, it is contemplated that a routing system according to the present invention may be used for additional purposes beyond routing telephone calls in the manner described above. For instance, routing system 15 might broadcast various types of messages (e.g., local weather information or advertising) to the various wireless devices 12, either by establishing telephone calls with such wireless devices or in any other manner described above.

Conclusion.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

Also, several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

What is claimed is:

1. An apparatus for wireless communications, said apparatus comprising:
(a) means for wirelessly communicating with a base station in accordance with a first protocol that permits said apparatus to function as a telephone;
(b) means for permitting a user to designate a telephone number for a remote device that the user desires to contact;
(c) means for identifying an access telephone number that is different than the telephone number;
(d) means for providing the access telephone number to the base station, in accordance with the first protocol, so as to indicate that a connection is desired with a routing system corresponding to the access telephone number; and
(e) means for providing the telephone number to the routing system in accordance with a second protocol, so as to indicate that a connection is desired with the remote device.

2. An apparatus according to claim 1, wherein said means (c) and (e) are included within a subscriber identity module (SIM) in said apparatus.

3. An apparatus according to claim 2, wherein said SIM also stores subscriber information for plural different mobile networks.

4. An apparatus according to claim 1, wherein said means (c) identifies the access telephone number based on at least one of a current telephone number for said apparatus and a current location of said apparatus.

5. An apparatus according to claim 1, further comprising:
(f) means for analyzing the telephone number; and
(g) means for activating said means (d) and (e) only if the telephone number satisfies a predetermined condition.

6. An apparatus according to claim 5, wherein the predetermined condition includes a criterion based on amount of toll charges for placing a call to the telephone number directly via the base station.

7. An apparatus according to claim 1, wherein the second protocol comprises a short message service (SMS) protocol.

8. An apparatus according to claim 1, wherein the telephone number is provided to the routing system by transmitting the telephone number to the base station via a channel used for signaling.

9. An apparatus according to claim 1, wherein the telephone number is provided to the routing system by transmitting the telephone number to the base station via a channel used for data communications between said apparatus and the routing system.

10. An apparatus according to claim 1, wherein said means (e) provides the telephone number to the routing system after the connection has been established.

11. An apparatus according to claim 1, further comprising:
(f) means for registering with said base station to accept incoming telephone calls.

12. An apparatus according to claim 11, further comprising:
(g) means for, shortly after registering by said means (f), transmitting a message to the routing system, said message indicating that said apparatus is so registered.

13. A subscriber identity module (SIM) for insertion into a wireless device, said SIM comprising:
a memory for storing data and computer-executable process steps; and
a processor for executing said process steps and for accessing said data, said process steps comprising steps to:
(a) input a telephone number;
(b) input an instruction to call the telephone number;
(c) identify an access telephone number that is different than the telephone number;
(d) cause the wireless device to establish a connection to a routing system corresponding to the access telephone number; and
(e) cause the wireless device to transmit the telephone number to the routing system in a manner so as to indicate that a connection is desired with a remote device corresponding to the telephone number.

14. A SIM according to claim 13, wherein the data stored in said memory include subscriber information for plural different mobile networks.

15. A SIM according to claim 14, wherein said process steps further comprise steps to:
(f) input location information indicating where the wireless device is located; and
(g) cause the wireless device to register with one of said different mobile networks, said one being selected based on the location information.

16. A SIM according to claim 14, wherein said process steps further comprise a step to:
(f) cause the wireless device to download information to update said subscriber information.

17. A SIM according to claim 13, wherein the access telephone number is identified in step (c) based on at least one of a current telephone number for said wireless device and a current location of said wireless device.

18. A SIM according to claim 13, wherein said process steps further comprise a step to:
(f) cause said wireless device to register with a base station to accept incoming telephone calls.

19. A SIM according to claim 18, wherein said process steps further comprise a step to:
(g) shortly after registering in step (f), transmit a message to the routing system, said message indicating that said wireless device is so registered.

20. A SIM according to claim 13, wherein said step (e) causes the wireless device to transmit the telephone number to the routing system using a short message service (SMS) protocol.

21. A SIM according to claim 13, wherein said step (e) causes the wireless device to transmit the telephone number to the routing system by transmitting the telephone number to a base station via a channel used for signaling.

22. A SIM according to claim 13, wherein said step (e) causes the wireless device to transmit the telephone number to the routing system by transmitting the telephone number to a base station via a channel used for data communications between said wireless device and the routing system.

23. A SIM according to claim 13, wherein said step (e) causes the wireless device to transmit the telephone number to the routing system after the connection has been established.

24. A method for facilitating telephone-based communications, said method comprising:
(a) assigning a contact telephone number to each of plural subscribers;
(b) receiving from a particular subscriber from among the plural subscribers an electronic message that has been formatted in accordance with an established protocol, said message identifying a current telephone number for the particular subscriber;
(c) receiving a telephone call on the contact telephone number for the particular subscriber; and
(d) automatically forwarding the telephone call to the current telephone number by dialing the current telephone number.

25. A method according to claim 24, wherein step (d) further comprises routing the telephone call to a local device prior to dialing the current telephone number.

26. A method according to claim 24, wherein the particular subscriber communicates using a wireless device that stores access information for plural different wireless networks, and wherein said method further comprises a step of downloading to said wireless device updating information to update said access information.

27. A method according to claim 26, wherein said updating information includes information regarding how to transmit the electronic message of step (b) via a specific one of the wireless networks.

28. A method according to claim 26, wherein said updating information includes access information for an additional wireless network.

29. A method according to claim 26, further comprising a step of downloading electronic cash to said wireless device.

30. A method according to claim 26, further comprising a step of downloading an audio file to said wireless device.

31. A method according to claim 24, further comprising steps of maintaining a database of geographic information that includes geographic positions of at least some of the plural subscribers and providing said geographic information on request.

32. A method according to claim 24, further comprising a step of maintaining a subscriber database that includes contact telephone numbers, connection statuses and current telephone numbers for said plural subscribers.

33. A method according to claim 32, further comprising a step of updating the subscriber database based on messages received in the established protocol.

34. A method according to claim 33, further comprising steps of identifying contact telephone numbers for incoming telephone calls and routing each said incoming telephone call to the current telephone number associated with the contact telephone number for said each incoming telephone call in the subscriber database.

35. An apparatus for insertion into a wireless device, said apparatus comprising:
(a) means for inputting a telephone number;
(b) means for inputting an instruction to call the telephone number;
(c) means for identifying an access telephone number that is different than the telephone number;
(d) means for causing the wireless device to establish a connection to a routing system corresponding to the access telephone number; and
(e) means for causing the wireless device to transmit the telephone number to the routing system in a manner so as to indicate that a connection is desired with a remote device corresponding to the telephone number.

36. An apparatus for facilitating telephone-based communications, said apparatus comprising:
(a) means for assigning a contact telephone number to each of plural subscribers;
(b) means for receiving from a particular subscriber from among the plural subscribers an electronic message that has been formatted in accordance with an established protocol, said message identifying a current telephone number for the particular subscriber;
(c) means for receiving a telephone call on the contact telephone number for the particular subscriber; and
(d) means for automatically forwarding the telephone call to the current telephone number by dialing the current telephone number.

37. An apparatus for communicating over plural different communications networks, said apparatus comprising:
(a) means for storing login information for plural different telephone communications networks;
(b) means for selecting one of the plural different telephone communications networks;
(c) means for, automatically in response to the selecting by said means (b), logging into the telephone communications network selected in step (b) so as to allow said apparatus to receive and initiate telephone calls;
(d) means for, automatically in response to the selecting by said means (b), transmitting a message via the telephone communications network selected in step (b) to an entity that is not a part of the telephone communications network selected in step (b),
wherein the message sent in step (d) identifies a telephone number at which said apparatus is reachable while logged into the telephone communications network selected in step (b), and
wherein the message is sent according to a pre-established protocol.

38. An apparatus according to claim 37, further comprising means for allowing a user of said apparatus to cause steps (b) through (d) to be repeated, with a different one of the plural different telephone communications networks being selected at each said repetition of step (b).
